(19) United States
(12) Patent Application Publication
(10) Pub. No.: US 2026/0100050 A1
(43) Pub. Date: Apr. 9, 2026

(54) INFORMATION PROCESSING DEVICE AND INFORMATION PROCESSING METHOD

(71) Applicant: TOYOTA JIDOSHA KABUSHIKI KAISHA, Toyota-shi (JP)

(72) Inventor: Hironori AOKAGE, Nagoya-shi (JP)

(73) Assignee: TOYOTA JIDOSHA KABUSHIKI KAISHA, Toyota-shi (JP)

(21) Appl. No.: 19/212,948

(22) Filed: May 20, 2025

(30) Foreign Application Priority Data
Oct. 3, 2024 (JP) 2024-174635

(51) Int. Cl. G06V 20/56; G06T 3/4038; G06T 5/70

(52) U.S. Cl. CPC G06V 20/56; G06T 3/4038; G06T 5/70

(57) ABSTRACT

The information processing device includes a storage unit, a controller, and a communication unit. The storage unit is configured to store camera videos captured by an in-vehicle camera without performing an obfuscation. The controller is configured to generate an obfuscated video obtained by obfuscating the camera videos. The communication unit is configured to transmit the obfuscated video to a server.

### CROSS-REFERENCE TO RELATED APPLICATION

This application claims priority to Japanese Patent Application No. 2024-174635 filed on Oct. 3, 2024. The disclosure of the above-identified application, including the specification, drawings, and claims, is incorporated by reference herein in its entirety.

### BACKGROUND

### 1. Technical Field

The present disclosure relates to an information processing device and an information processing method.

### 2. Description of Related Art

In recent years, a driving recorder that records a video of surroundings of a vehicle has become widespread. The video recorded by the driving recorder needs to be sufficiently considered with regard to privacy concerns. Therefore, some countries prohibit uploading a video recorded by a driving recorder to a server unless privacy concerns are addressed.

Therefore, a technique is known in which, in a case where a video is provided to a third party, the video is obfuscated before being provided to the third party. For example, Japanese Unexamined Patent Application Publication No. 2023-125946 (JP 2023-125946 A) discloses an image processing device that extracts information on an obfuscation target area from an image captured by a camera, stores the information in association with the image, and performs an obfuscation process based on the information when providing the image.

### SUMMARY

However, in a case where a video is provided to the police, an insurance company, or the like, an obfuscated video may not be effective as evidence.

The present disclosure made in view of such circumstances enables acquisition of a camera video before obfuscation that can be used as evidence.

An information processing device according to an aspect of the present disclosure includes a storage unit, a controller, and a communication unit.

The storage unit is configured to store a camera video captured by an in-vehicle camera without performing obfuscation.

The controller is configured to generate an obfuscated video obtained by obfuscating the camera video.

The communication unit is configured to transmit the obfuscated video to a server.

An information processing method according to an aspect of the present disclosure includes:
storing a camera video captured by an in-vehicle camera without performing obfuscation, and transmitting an obfuscated video obtained by obfuscating the camera video to a server, by an information processing device;
receiving the obfuscated video from the server and displaying the obfuscated video in response to a first instruction from a user, by a mobile terminal; and
receiving the camera video from the information processing device and storing the camera video in response to a second instruction from the user, by the mobile terminal.

According to the aspects of the present disclosure, it is possible to acquire the camera video before the obfuscation that can be used as evidence.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration example of an information processing system according to an embodiment; and

FIG. 2 is a sequence diagram showing a processing procedure example of the information processing method according to the embodiment.

### DETAILED DESCRIPTION OF EMBODIMENTS

### Configuration of Information Processing System

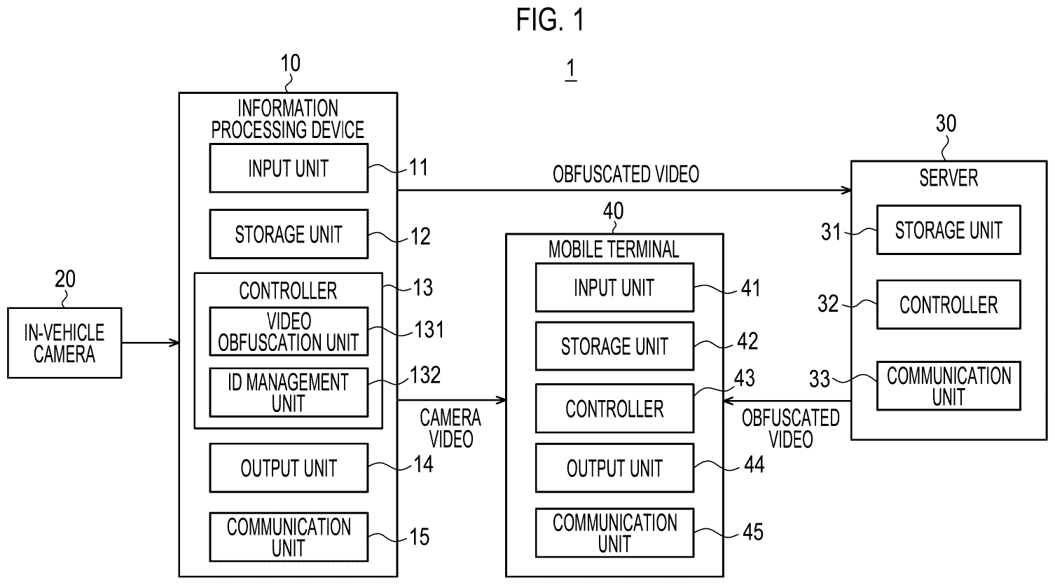

A configuration of an information processing system according to an embodiment will be described with reference to FIG. 1. The information processing system 1 shown in FIG. 1 includes an information processing device 10, an in-vehicle camera 20, a server 30, and a mobile terminal 40.

The in-vehicle camera 20 is connected to the information processing device 10. The in-vehicle camera 20 may be integrated with the information processing device 10. A plurality of the in-vehicle camera 20 may be mounted on a vehicle. The in-vehicle camera 20 has an imaging device and captures a video of the periphery of the vehicle.

The information processing device 10 is a device mounted on a vehicle and performs wireless communication with the server 30 and the mobile terminal 40. The information processing device 10 illustrated in FIG. 1 includes an input unit 11, a storage unit 12, a controller 13, an output unit 14, and a communication unit 15.

The input unit 11 includes at least one input interface. The input interface is, for example, a physical key, an electrostatic capacity key, a pointing device, a touch screen provided integrally with a display, or a microphone. The input unit 11 includes an interface with the in-vehicle camera 20. The input unit 11 inputs real-time video (hereinafter, referred to as “camera video”) captured by the in-vehicle camera 20.

The input unit 11 inputs the event from various sensors mounted on the vehicle. The various sensors are an acceleration sensor that detects an impact, a sensor related to an auto alarm (security alarm), a sensor that detects that a person or an object approaches the vehicle, and the like. The sensor related to the auto alarm is an intrusion sensor that detects intrusion into the vehicle, a tilt sensor that detects a tilt of the vehicle, a sensor that detects that a door or a trunk is unlocked by an unauthorized method, a sensor that detects that a hood is opened, and the like.

The storage unit 12 includes at least one semiconductor memory, at least one magnetic memory, at least one optical memory, or any combination thereof. The semiconductor memory is, for example, a random-access memory (RAM), a read-only memory (ROM), or a flash memory. The flash memory is, for example, a solid-state drive (SSD). The magnetic memory is, for example, a hard disk drive (HDD).

The output unit 14 includes at least one output interface. The output interface is, for example, a display that outputs information by video or a speaker that outputs information by sound. The display is, for example, a liquid crystal display (LCD) or an organic electroluminescent (EL) display.

The communication unit 15 includes at least one wireless communication interface for performing wireless communication with the server 30 and the mobile terminal 40.

The controller 13 includes at least one processor, at least one programmable circuit, at least one dedicated circuit, or any combination thereof. The processor is a general-purpose processor, such as a central processing unit (CPU) or a graphics processing unit (GPU), or a dedicated processor specialized for specific processing. The programmable circuit is, for example, a field-programmable gate array (FPGA). The dedicated circuit is, for example, an application specific integrated circuit (ASIC). The controller 13 executes processing related to an operation of the information processing device 10 while controlling each of the units of the information processing device 10. The controller 13 includes a video obfuscation unit 131 and an ID management unit 132.

The video obfuscation unit 131 acquires the camera video captured by the in-vehicle camera 20, and performs the obfuscation process on the camera video to generate the obfuscated video. Specifically, the video obfuscation unit 131 detects an image related to privacy from the camera video. The video obfuscation unit 131 may input the camera video to the machine learning model trained with the image related to privacy as a correct label to detect the image related to privacy. The image related to privacy may include an image corresponding to personal information, such as a face of a person, and an image that can specify a person, such as a license plate. The video obfuscation unit 131 performs a blur processing, a mosaic processing, a fill processing, or the like on the image related to the privacy by the existing image processing technology.

The ID management unit 132 assigns the same ID (identification number) or an ID having a clear correspondence to the camera video and the obfuscated video obtained by performing the obfuscation process on the camera video as metadata. The storage unit 12 stores the camera video together with a first ID. The communication unit 15 transmits the obfuscated video generated by the video obfuscation unit 131 to the server 30 together with the second ID. The second ID is an ID that is the same as or corresponds to the first ID.

The server 30 includes a storage unit 31, a controller 32, and a communication unit 33.

The storage unit 31 includes at least one semiconductor memory, at least one magnetic memory, at least one optical memory, or any combination thereof. The storage unit 31 stores the obfuscated video together with the second ID.

The controller 32 includes at least one processor, at least one programmable circuit, at least one dedicated circuit, or any combination thereof. The controller 32 executes processing related to the operation of the server 30 while controlling each of the units of the server 30.

The communication unit 33 includes at least one wireless communication interface for performing wireless communication with the information processing device 10 and the mobile terminal 40. The communication unit 33 receives the obfuscated video from the information processing device 10 and stores the obfuscated video in the storage unit 31. The communication unit 33 transmits the obfuscated video to the mobile terminal 40.

The mobile terminal 40 includes an input unit 41, a storage unit 42, a controller 43, an output unit 44, and a communication unit 45.

The input unit 41 includes at least one input interface. The input interface is, for example, a physical key, an electrostatic capacity key, a pointing device, a touch screen provided integrally with a display, or a microphone.

The communication unit 45 includes at least one wireless communication interface for performing wireless communication with the server 30 and the mobile terminal 40. The communication unit 45 receives the obfuscated video from the server 30 in response to the first instruction from the user. The communication unit 45 receives the camera video from the information processing device 10 in response to a second instruction from the user. The mobile terminal 40 and the information processing device 10 are assumed to be relatively close to each other, so that Wi-Fi (registered trademark) can be used to receive the camera video.

The storage unit 42 includes at least one semiconductor memory, at least one magnetic memory, at least one optical memory, or any combination thereof. The storage unit 42 stores the camera video together with a first ID.

The user installs an application (hereinafter, referred to as “image viewing application”) that enables the user to view the obfuscated video stored in the server 30 and download the camera video stored in the information processing device 10 on the mobile terminal 40 and stores the application in the storage unit 42.

The output unit 44 includes at least one output interface. The output interface is, for example, a display that outputs information by video or a speaker that outputs information by sound. The output unit 44 displays the obfuscated video in response to an operation of the user of the video viewing application.

The controller 43 includes at least one processor, at least one programmable circuit, at least one dedicated circuit, or any combination thereof. The controller 43 executes processing according to an operation of the video viewing application of the user, as will be described later.

### Operation Example

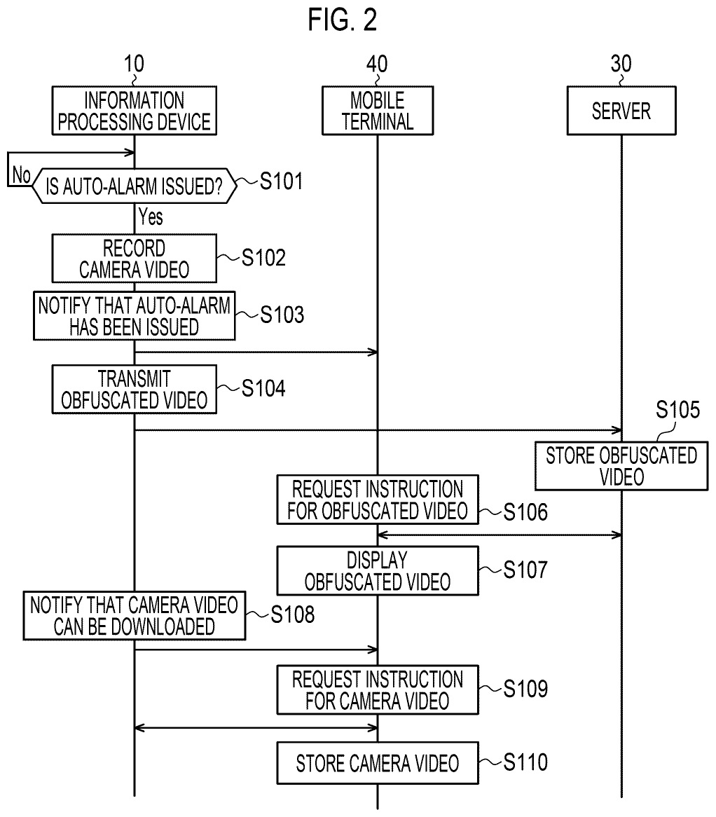

Next, a processing procedure example of the information processing method in a case where the parked vehicle issues the auto-alarm will be described with reference to FIG. 2.

The information processing device 10 waits until the auto-alarm is issued, and when the auto-alarm is issued (S101—Yes), activates the in-vehicle camera 20 and starts recording the camera video (S102). At the same time, the mobile terminal 40 is notified that the auto-alarm has been issued (S103).

Next, the information processing device 10 generates the obfuscated video from the camera video and transmits the obfuscated video to the server 30 (S104). The server 30 stores the obfuscated video received from the information processing device 10 in the storage unit 31 (S105). When the information processing device 10 generates the obfuscated video by the video obfuscation unit 131, the information processing device 10 may notify the mobile terminal 40 that the obfuscated video can be viewed.

When the user views the obfuscated video, the user operates the video viewing application installed in the mobile terminal 40 and taps, for example, a viewing button. The mobile terminal 40 transmits the request instruction for the obfuscated video to the server 30 in response to the operation of the video viewing application (S106). In a case where the server 30 receives the request instruction for the obfuscated video from the mobile terminal 40, the server 30 transmits the requested obfuscated video to the mobile terminal 40. When the mobile terminal 40 receives the obfuscated video from the server 30, the mobile terminal 40 displays the obfuscated video on the output unit 44 (S107).

The information processing device 10 notifies the mobile terminal 40 that the camera video can be downloaded from the information processing device 10 (S108). The notification can be omitted.

When the user determines that the camera video corresponding to the viewed obfuscated video is needed to be provided to the police, the insurance company, or the like as evidence, the user operates the video viewing application and taps, for example, a download button of the camera video. The mobile terminal 40 transmits the request instruction for the camera video to the information processing device 10 in response to the operation of the video viewing application (S109). The request instruction for the camera video includes an ID (second ID) of the obfuscated video. When the information processing device 10 receives the request instruction for the camera video from the mobile terminal 40, the information processing device 10 transmits the camera video to the mobile terminal 40, to which the ID (the first ID) identical to or corresponding to the ID (the second ID) of the obfuscated video is assigned. When the mobile terminal 40 receives the camera video from the information processing device 10, the mobile terminal 40 stores the camera video in the storage unit 42 (S110). The mobile terminal 40 may display the camera video on the output unit 44 in response to an operation of the video viewing application in addition to downloading the camera video.

As described above, the information processing device 10 stores the camera video captured by the in-vehicle camera 20 without obfuscating the camera video, and transmits the obfuscated video obtained by obfuscating the camera video to the server 30. The mobile terminal 40 receives and displays the obfuscated video from the server 30 in response to a first instruction from the user, and receives and stores the camera video from the information processing device 10 in response to a second instruction from the user. Therefore, the user can acquire the non-anonymized camera video that can be evidence after confirming that something has occurred by viewing the obfuscated video in advance. The camera video stored in the in-vehicle camera 20 is automatically deleted after a predetermined time has elapsed in accordance with the storage capacity, but the mobile terminal 40 can download the camera video before the camera video is deleted.

### Program

The function of the information processing device 10 may be realized by executing the program according to the present embodiment by the processor as the controller 13 (that is, by software). The program causes the computer to function as the information processing device 10 by causing the computer to execute the operation of the information processing device 10.

The program may be stored on a non-transitory computer-readable medium. The medium is a flash memory, a magnetic recording device, an optical disk, an optical magnetic recording medium, a ROM, or the like. The program is distributed by selling, transferring, or lending the portable medium. The portable medium is a secure digital (SD) card, a digital versatile disc (DVD), a compact disc read-only memory (CD-ROM), or the like, in which the program is stored. The program may be stored in the storage of the server and the program may be transferred from the server to another computer to distribute the program. The program may be provided as a program product.

For example, a computer temporarily stores the program recorded on the portable recording medium or the program transferred from the server in a main storage device. Then, the computer reads the program stored in the main storage device by means of a processor, and executes processing according to the read program by means of the processor. The computer may read the program directly from the portable recording medium and execute the processing according to the program. The computer may sequentially execute the processing according to the received program each time the program is transferred from the server to the computer. The processing may be executed by a so-called application service provider (ASP) type service that does not transfer the program from the server to the computer and realizes the function solely by the execution instruction and the result acquisition. The program includes information provided for processing by an electronic computer and information equivalent to the program. For example, data that is not a direct command with respect to a computer but has a property of defining processing of the computer corresponds to “information equivalent to the program.”

The above-described embodiments are representative examples, and various modifications or changes can be made without departing from the spirit of the present disclosure. For example, a plurality of configuration blocks or processing steps described in the embodiment can be combined into one or one can be divided into a plurality.

What is claimed is:

1. An information processing device comprising:
a storage unit configured to store a camera video captured by an in-vehicle camera without performing obfuscation;
a controller configured to generate an obfuscated video obtained by obfuscating the camera video; and
a communication unit configured to transmit the obfuscated video to a server.

2. The information processing device according to claim 1, wherein the controller detects an image related to privacy from the camera video, and performs a blurring process, a mosaic process, or a filling process on the image to obfuscate the camera video.

3. The information processing device according to claim 1, wherein:
the storage unit stores the camera video together with a first identification; and
the communication unit transmits the obfuscated video to the server together with a second identification identical to or corresponding to the first identification.

4. An information processing method comprising:
storing a camera video captured by an in-vehicle camera without performing obfuscation, and transmitting an obfuscated video obtained by obfuscating the camera video to a server, by an information processing device;
receiving the obfuscated video from the server and displaying the obfuscated video in response to a first instruction from a user, by a mobile terminal; and
receiving the camera video from the information processing device and storing the camera video in response to a second instruction from the user, by the mobile terminal.
